(19) United States
(12) Patent Application Publication
(10) Pub. No.: US 2011/0311236 A1
(43) Pub. Date: Dec. 22, 2011

(54) OPTICAL AMPLIFIER, CONTROL METHOD THEREFOR, AND OPTICAL TRANSMISSION SYSTEM

(76) Inventor: Ryuji Aida, Tokyo (JP)

(21) Appl. No.: 13/138,512

(22) PCT Filed: Mar. 16, 2010
(86) PCT No.: PCT/JP2010/001872

§ 371 Date: Aug. 29, 2011

(30) Foreign Application Priority Data
Mar. 26, 2009 (JP) 2009-077100

(51) Int. Cl. H04B 10/04; H01S 3/13

(52) U.S. Cl. 398/193; 359/337.1

(57) ABSTRACT

Provided are an optical amplifier, a control method therefor, and an optical transmission system that can use a simple technique to correct SRS tilt generated in a transmission path after a back-stage amplifier out of two amplifiers, which respectively amplify an input optical signal in a front stage and a back stage of a variable attenuator, in accordance with the number of wavelengths of the optical signal transmitted on the transmission path. A control parameter for controlling the two amplifiers and the attenuator is determined so as to correct a spectral slope caused by stimulated Raman scattering of the optical signal based on network information received from another device, and the two amplifiers and the attenuator are controlled based on the control parameter.

### TECHNICAL FIELD

The present invention relates to an optical amplifier that amplifies an optical signal transmitted on a communication network, a control method therefor, and an optical transmission system.

### BACKGROUND ART

In a wavelength-division multiplexing optical transmission system, there is a need to increase the number of wavelengths and achieve longer-distance transmission of optical signals that can be transmitted at one time on a single transmission path of the system. Additionally, to achieve such an increase in the number of wavelengths and longer-distance transmission of optical signals, there is a need to increase the output of an optical amplifier. It is to be noted that Patent Document 1 discloses a related art.

### PRIOR ART DOCUMENT

### Patent Document

Patent Document 1: Japanese Unexamined Patent Application, First Publication No. 2003-264511

### DISCLOSURE OF THE INVENTION

### Problems to be Solved by the Invention

Here, when the output of an optical amplifier provided in a wavelength-division multiplexing optical transmission system increases, stimulated Raman scattering (SRS), which is one of the nonlinear phenomena, results in a noticeable spectral slope (SRS tilt). Therefore, this SRS tilt must be corrected to maintain the transmission quality of the system.

FIG. 4 is a diagram showing an example of the generation of SRS tilt.

The SRS tilt is determined in accordance with the type of the transmission fiber, the distance, the signal band, and the total power of the light that is input to the transmission path (output power of the optical amplifier). FIG. 4 shows an example of the amount of SRS tilt that is generated with respect to the power input to a transmission path when the transmission path is a single mode fiber (SMF) of 80 km and the signal band is the C-band with 40 wavelengths (with the wavelengths arranged at intervals of 100 GHz). Additionally, as shown in FIG. 4, when the total output power of the optical amplifier increases from 18 dBm to 26 dBm, the SRS tilt generated on the transmission path becomes 4 dB/(C-band with 40 wavelengths). As the output of the optical amplifier increases, influences due to this SRS tilt become impossible to ignore and need correcting. Additionally, when an optical cross-connect device has been provided between networks, the number of wavelengths of the optical signal transmitted on each transmission path changes in accordance with switching performed in the optical cross-connect device. For this reason, whenever the change takes place, the control for correcting the SRS tilt in the optical amplifier must be changed.

Accordingly, it is an exemplary object of the present invention to provide an optical amplifier, a control method therefor, and an optical transmission system that can use a simple technique to correct SRS tilt generated in a transmission path after a back-stage amplifier out of two amplifiers, which respectively amplify an input optical signal in a front stage and a back stage of a variable attenuator, in accordance with the number of wavelengths of the optical signal transmitted on the transmission path.

### Means for Solving the Problems

To achieve the above exemplary object, the present invention is an optical amplifier which includes: a front-stage amplifier that amplifies an input optical signal; an attenuator that attenuates an output of the front-stage amplifier; a back-stage amplifier that amplifies an output of the attenuator; a control parameter determination unit that determines a control parameter for controlling the front-stage amplifier, the back-stage amplifier, and the attenuator so as to correct a spectral slope caused by stimulated Raman scattering of the optical signal based on network information received from another device; and a control unit that controls the front-stage amplifier, the back-stage amplifier, and the attenuator based on the control parameter.

Moreover, the present invention is an optical transmission system which includes node devices that form a communication network; a network management device that acquires network information; and an optical amplifier that amplifies an optical signal between the node devices, wherein the optical amplifier includes: a front-stage amplifier that amplifies an input optical signal; an attenuator that attenuates an output of the front-stage amplifier; a back-stage amplifier that amplifies an output of the attenuator; a network information reception unit that receives the network information from a node device that received the network information from the network management device; a control parameter determination unit that determines a control parameter for controlling the front-stage amplifier, the back-stage amplifier, and the attenuator so as to correct a spectral slope caused by stimulated Raman scattering of the optical signal based on the received network information; and a control unit that controls the front-stage amplifier, the back-stage amplifier, and the attenuator based on the control parameter.

Furthermore, the present invention is a control method for an optical amplifier which includes: determining a control parameter for controlling a front-stage amplifier that amplifies an input optical signal, an attenuator that attenuates an output of the front-stage amplifier, and a back-stage amplifier that amplifies an output of the attenuator so as to correct a spectral slope caused by stimulated Raman scattering of the optical signal based on network information received from another device; and controlling the front-stage amplifier, the back-stage amplifier, and the attenuator, which are provided in the optical amplifier, based on the control parameter.

### Effect of the Invention

In accordance with the present invention, another device (e.g., a network management device) transmits the network information to a node device (e.g., at predetermined time intervals). As a result, each optical amplifier calculates (e.g., every predetermined time interval) the total optical output power in accordance with the network information (e.g., the number of wavelengths of the optical signal passing through the optical amplifier itself) as occasion arises, and controls Erbium-doped fiber amplifiers and a variable attenuator based on the optical output power that is appropriate for the network information (e.g. the abovementioned number of wavelengths). This enables the SRS tilt to be corrected with a simple technique.

### BRIEF DESCRIPTION OF THE DRAWINGS

FIG. 1 is a block diagram showing the configuration of an optical transmission system according to an exemplary embodiment of the present invention.

FIG. 2 is a diagram showing a functional configuration of an optical amplifier according to the same exemplary embodiment.

FIG. 3 is a diagram showing the process flow in the optical transmission system according to the same exemplary embodiment.

FIG. 4 is a diagram showing an example of the generation of SRS tilt.

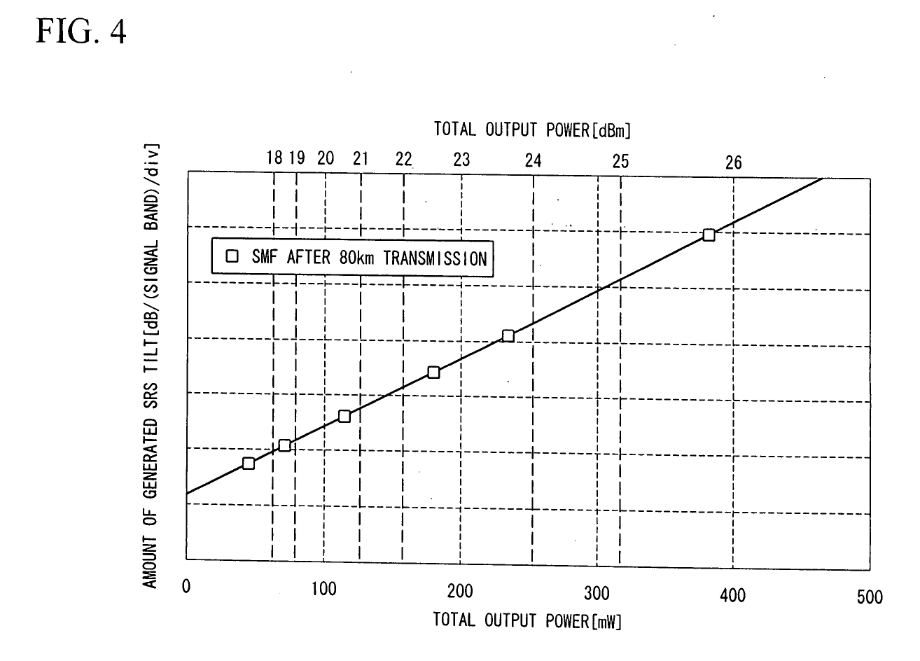

### MODE FOR CARRYING OUT THE INVENTION

Hereinafter, an optical transmission system and an optical amplifier according to an exemplary embodiment of the present invention will be described with reference to the drawings.

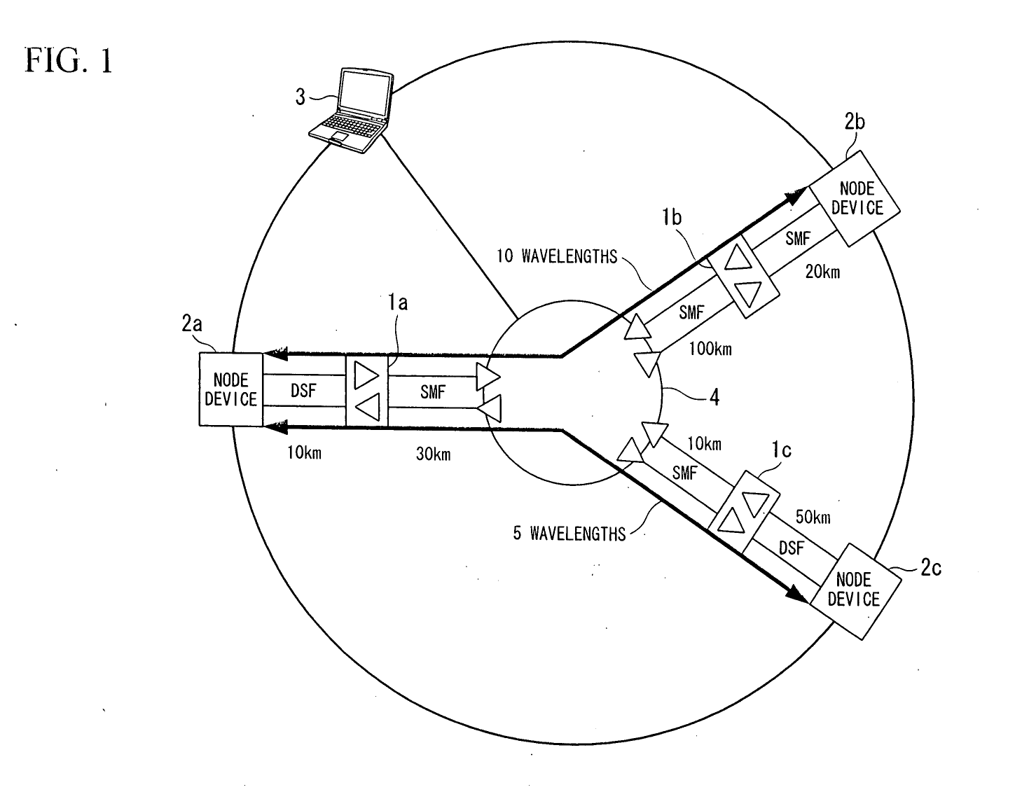

FIG. 1 is a block diagram showing the configuration of an optical transmission system according to the same exemplary embodiment.

In this figure, reference symbols 1a to 1c represent optical amplifiers, reference symbols 2a to 2c represent node devices, reference symbol 3 represents a network management device, and reference symbol 4 represents an optical cross-connect device. As shown in this figure, in the optical transmission system in accordance with the present exemplary embodiment, the node devices 2a to 2c are each connected in communication via optical transmission cables and the optical cross-connect device 4 to another node device. Moreover, the optical amplifiers 1a to 1c (hereinafter sometimes collectively termed “optical amplifier(s) 1”) for amplifying the optical signal are respectively connected between the node device 2a and the optical cross-connect device 4, between the node device 2b and the optical cross-connect device 4, and between the node device 2c and the optical cross-connect device 4. Furthermore, the network management device 3 for acquiring network information is connected to the optical cross-connect device 4 and to each of the node devices 2a to 2c.

Additionally, each of the node devices 2a to 2c transmits and receives a wavelength-multiplexed optical signal to and from another node device via the optical cross-connect device 4. In FIG. 1, a multiplexed optical signal including ten wavelengths is transmitted and received between the node device 2a and the node device 2b. Moreover, a multiplexed optical signal including five wavelengths is transmitted and received between the node device 2a and the node device 2c.

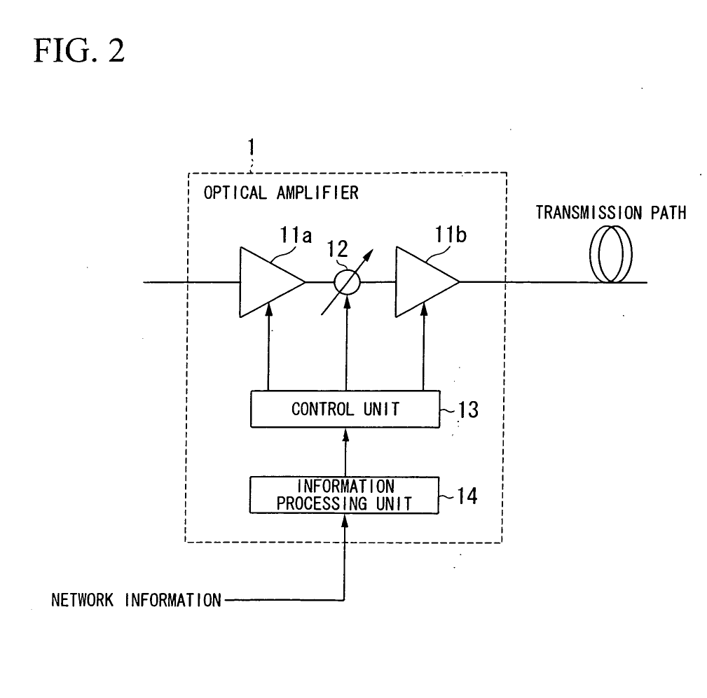

FIG. 2 is a diagram showing the functional configuration of an optical amplifier.

As shown in this figure, the optical amplifier 1 includes two Erbium-doped optical fiber amplifiers (hereinafter termed EDFAs) 11a and 11b, which are provided in the front stage and the back stage of a variable attenuator (hereinafter termed VOA) described next and amplify an input optical signal, the VOA 12 that is provided between the front-stage EDFA 11a and the back-stage EDFA 11b and performs spectral slope correction, a control unit 13 that controls the EDFAs 11a and 11b and the VOA 12 based on control parameters, and an information processing unit (control parameter determination unit) 14 that determines the control parameters based on received network information.

Additionally, in the optical transmission system of the present exemplary embodiment, the optical amplifier 1 performs a process of receiving network information from a node device that received the network information from the network management device 3, a process of determining control parameters for controlling the two EDFAs 11a and 11b and the VOA 12 to correct a spectral slope caused by stimulated Raman scattering of the optical signal based on the received network information, and a process of controlling the two EDFAs 11a and 11b and the VOA 12 based on those control parameters.

Thus, it is an exemplary object to provide an optical amplifier, a control method therefor, and an optical transmission system that can use a simple technique to correct SRS tilt generated on a transmission path in accordance with the number of wavelengths of the optical signal transmitted on the transmission path.

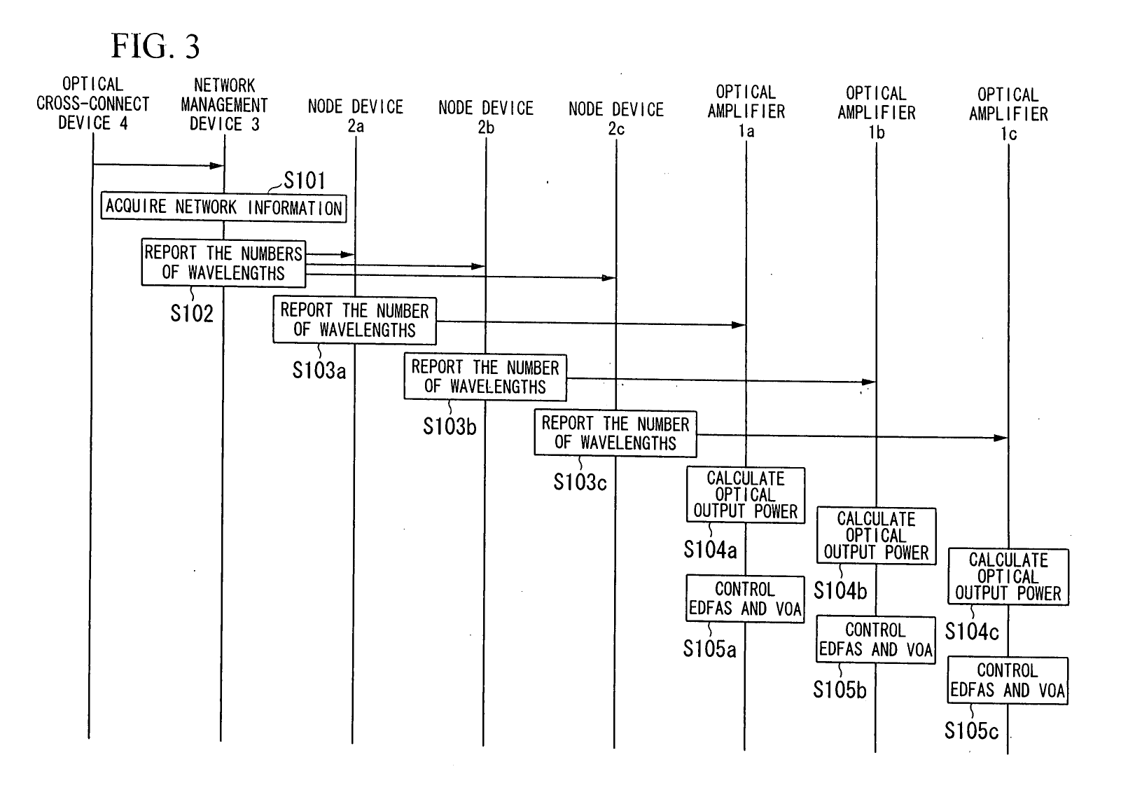

FIG. 3 is a diagram showing the process flow in an optical transmission system.

Subsequently, the process flow in an optical transmission system will be described.

In an optical transmission system such as that shown in FIG. 1, the transmission distances between the node devices 2a to 2c and the optical amplifiers 1a to 1c, and the distances of transmission paths between the optical amplifiers 1a to 1c and the optical cross-connect device 4 vary from 10 km to 100 km. Additionally, when constructing a network for the optical transmission system, the output of the optical amplifier between the nodes is determined and set based on the distance between the node devices. For example, it is set to 0 dBm/ch if the transmission path is less than or equal to 10 km, it is set to +5 dBm/ch if the transmission path is 11 km to 50 km, and it is set to +10 dBm/ch if the transmission path is 51 km to 200 km. That is, the optical output is determined for each channel between node devices based on the idea in which the optical amplifier 1 installed on a long transmission path is set to high optical output so as to ensure the required optical signal-to-noise ratio (OSNR) of a transponder between terminal stations on the transmission path, whereas the optical output of the optical amplifier 1 installed on a short transmission path is not increased unnecessarily so as to suppress nonlinear degradation. The network management device 3 specifies the optical output per channel, the distance, the transmission path information, and the like at the time of constructing the network for the optical transmission system.

Additionally, as shown in FIG. 1, let us suppose that, at the initial operation, a channel of a multiplexed optical signal including ten wavelengths is established between the node device 2a and node device 2b, and a channel of a multiplexed optical signal including five wavelengths is established between the node device 2a and node device 2c. As a result, an optical signal of fifteen wavelengths is transmitted between the node device 2a and the optical cross-connect device 4, an optical signal of ten wavelengths is transmitted between the node device 2b and the optical cross-connect device 4, and an optical signal of five wavelengths is transmitted between the node device 2c and the optical cross-connect device 4. The optical amplifier 1 multiplies the output per channel by information on the number of wavelengths (band) to calculate the total optical output power (control parameter). Thus, in an optical transmission system including the optical cross-connect device 4, the number of wavelengths differs on each path, making the information on the number of wavelengths (band) an important parameter. Additionally, in the configuration of the optical transmission system including the optical cross-connect device 4, it is assumed that the path of the optical signal is frequently switched. As a consequence, the number of wavelengths changes on each transmission path, and it is therefore important to report the information on the number of wavelengths (band) dynamically to the optical amplifier 1.

Additionally, in the optical transmission system of the present exemplary embodiment, the network management device 3 first acquires network information from the optical cross-connect device 4 (Step S101). This network information is, for example, the number of wavelengths of the optical signal being transmitted on each transmission path (i.e. the number of multiplexed wavelengths of the optical signal amplified by the optical amplifier 1). The network management device 3 then reports the numbers of wavelengths to the node devices 2a to 2c (Step S102). In this case, the network management device 3 reports to the node device 2a the number of wavelengths (15 wavelengths) of the optical signal channel established between the node device 2a and the optical cross-connect device 4. Moreover, the network management device 3 reports to the node device 2b the number of wavelengths (10 wavelengths) of the optical signal channel established between the node device 2b and the optical cross-connect device 4. Furthermore, the network management device 3 reports to the node device 2c the number of wavelengths (5 wavelengths) of the optical signal channel established between the node device 2c and the optical cross-connect device 4. It is to be noted that the optical cross-connect device 4 detects the wavelengths of the received optical signal, and reports the number of these wavelengths to the network management device 3. As a result, the network management device 3 can acquire the numbers of wavelengths of the optical signals on the channels between all the node devices passing via the optical cross-connect device 4.

Additionally, when the node device 2a receives the number of wavelengths of the optical signal channel established between the node device 2a and the optical cross-connect device 4 from the network management device 3, it puts the number of wavelengths in a control signal and reports it to the optical amplifier 1a (Step S103a). The information processing unit 14 of the optical amplifier la then detects the number of wavelengths from the received control signal, multiples the output power per channel by the number of wavelengths to calculate the total optical output power (Step S104a). The control unit 13 of the optical amplifier 1a then controls the EDFAs 11a and 11b and the VOA 12 of the optical amplifier 1a based on the optical output power calculated by the information processing unit 14 (Step S105a).

Similarly, when the node device 2b receives the number of wavelengths of the optical signal channel established between the node device 2b and the optical cross-connect device 4 from the network management device 3, it puts the number of wavelengths in a control signal and reports it to the optical amplifier 1b (Step S103b). The information processing unit 14 of the optical amplifier 1b then detects the number of wavelengths from the received control signal, multiples the output power per channel by the number of wavelengths to calculate the total optical output power (Step S104b). The control unit 13 of the optical amplifier 1b then controls the EDFAs 11a and 11b and the VOA 12 of the optical amplifier 1b based on the optical output power calculated by the information processing unit 14 (Step S105b).

Similarly, when the node device 2c receives the number of wavelengths of the optical signal channel established between the node device 2c and the optical cross-connect device 4 from the network management device 3, it puts the number of wavelengths in a control signal and reports it to the optical amplifier 1c (Step S103c). The information processing unit 14 of the optical amplifier 1c then detects the number of wavelengths from the received control signal, multiples the output power per channel by the number of wavelengths to calculate the total optical output power (Step S104c). The control unit 13 of the optical amplifier 1c then controls the EDFAs 11a and 11b and the VOA 12 of the optical amplifier lc based on the optical output power calculated by the information processing unit 14 (Step S105c).

Here, the control unit 13 of each of the optical amplifiers 1a to 1c uses the total optical output power P4, the input power P1 of light received for input at the optical amplifier itself obtained from a photodiode PD (not shown) arranged in the front stage of the EDFA 11a in the optical amplifier itself, a fixed value C, and an attenuation amount correction value ΔL to calculate the attenuation amount A shown in equation (1). The EDFAs 11a and 11b and the VOA 12 of the optical amplifier 1 are then controlled based on this attenuation amount A. It is to be noted that the total optical output power P4 depends on the number of wavelengths and the output power per channel, which are determined by the requirements of the system. Moreover, the optical input power P1 depends on the transmission-path loss and the transmission output power of the front-stage node device. Furthermore, the attenuation amount correction value ΔL depends on the total optical output power P4 and the type and the transmission distance of the back-stage transmission path.

A=C+ΔL−(P4−P1) (1)

Additionally, equation (2) is an equation for calculating ΔL. In this equation, P0 is determined by the total optical power of the optical signal input to the transmission path (unless there is loss between the output of the optical amplifier 1 and an input to the transmission path, P0=P4), and changes depending on the number of wavelengths. Moreover, β is a coefficient [1/W·km·nm] that depends on the transmission path to which the total optical power is input. Furthermore, a is a proportional coefficient [1/nm] that depends on the design of the optical amplifiers. In addition, Leff is the effective length [km] of the transmission path to which the total optical power is input.

ΔL=4.34·β·P0·Leff/a (2)

It is to be noted that the total optical output power P4 in equation (1) is a set output value of the optical amplifier 1 derived from system requirements (determined from factors such as OSNR degradation, nonlinear degradation, total transmission distance). For example, when the transmission-path loss is 0 to 10 dB (corresponding to 0 to 50 km), the output of the optical amplifier is 0 dBm/ch, when the transmission-path loss is 10 to 20 dB (corresponding to 50 to 100 km), the output of the optical amplifier is 5 dBm/ch, and when the transmission-path loss is 20 to 30 dB (corresponding to 100 to 150 km), the output of the optical amplifier is 10 dBm/ch. A point to be noted here is that the output of the optical amplifier is defined by the output power per channel (if the output of the optical amplifier is not defined by the output per channel, but is defined only by the total power, the output power per channel will change in accordance with the number of wavelengths and the system does not function correctly). Therefore, in order to determine the total optical output power P4 of equation (1), the total power is calculated by multiplying the output power per channel by the number of wavelengths.

On the other hand, P1 in equation (1) is the input power to the optical amplifier 1. As mentioned above, a photodiode (PD) is usually provided in the front stage of the EDFA 11a in the optical amplifier 1 to detect the total input power. Since the photodiode can only detect the total power, it cannot be known whether the detected power represents the power of an optical signal of one wavelength that suffered a loss of 10 dB before passing along the transmission path, or the power of an optical signal of two wavelengths that suffered a loss of 13 dB before passing along the transmission path. That is, there is no information on the number of wavelengths on the P1 side. Therefore, information on the number of wavelengths is needed on the P4 side to calculate P4 and P1 in equation (1). It is to be noted that equation (1) is satisfied even if the power per channel is used. In that case, since P1 must be converted into power per channel, information on the number of wavelengths is needed on the P1 side. Moreover, P0 in equation (2) is determined by the total power (unless there is loss between the output from the optical amplifier 1 and the input to the transmission path, P0=P4), and it changes depending on the number of wavelengths. For this reason, information on the number of wavelengths is needed.

In addition, to make the system robust, the optical amplifier 1 has a tolerance to transmission-path loss. In the foregoing example (when the transmission-path loss is 0 to 10 dB (corresponding to 0 to 50 km), the output of the optical amplifier is 0 dBm/ch, when the transmission-path loss is 10 to 20 dB (corresponding to 50 to 100 km), the output of the optical amplifier is 5 dBm/ch, and when the transmission-path loss is 20 to 30 dB (corresponding to 100 to 150 kin), the output of the optical amplifier is 10 dBm/ch), the optical amplifier 1 has a tolerance of 10 dB. The actual transmission-path loss differs due to variation in the distances between locations where stations can be installed, and variation in loss on individual transmission path fibers. Consequently, the transmission-path loss cannot accurately be known until the stations are installed. Therefore, the optical amplifier 1 has a tolerance to loss in the optical amplifier itself (input dynamic range). This means that, even if P1 in equation (1) changes, the gain wavelength characteristics of the optical amplifier 1 can be kept flat by modifying the attenuation amount A by an amount corresponding to that change. As described above, Patent Document 1 discusses only total power. In contrast, the present application proposes an optical amplifier that is provided with an SRS tilt-correcting function that can be applied in a system where the number of wavelengths dynamically changes, such as an optical transmission system including the optical cross-connect device 4.

Additionally, the network management device 3 acquires the network information from the optical cross-connect device 4 at a predetermined time interval, and transmits it to the node devices 2a to 2c. As a result, each of the optical amplifiers 1a to 1c can calculate the total optical output power in accordance with the number of wavelengths of the optical signal passing through the optical amplifier itself every predetermined time interval, and can control the EDFAs 11a and 11b and the VOA 12 based on the optical output power that is appropriate for the number of wavelengths.

It is to be noted that the network management device 3 can not only acquire the number of wavelengths of the optical signal as described above from the optical cross-connect device 4 as network information, but also acquire other information, for example, information on the type of the optical fiber and the distance, and report this as network information to the node devices 2, and the optical amplifiers 1 can use such other network information in controlling the EDFAs 11a and 11b and the VOA 12.

It is to be noted that each of the above devices can include a computer system. Additionally, the steps of the processes described above can be stored in program format on a computer-readable recording medium, and performed by making the computer read and execute them. Here, a computer-readable recording medium denotes a magnetic disk, a magneto-optical disc, a compact disc read-only memory (CD-ROM), a digital versatile disc (DVD)-ROM, a semiconductor memory, etc. Moreover, the computer program can be distributed to a computer via a communication line, and executed by the computer that received it.

In addition, the program can realize some of the functions described above. Moreover, it can be a so-called differential file (differential program) that can realize the functions described above in combination with a program that is already stored in the computer system.

While the present invention has been particularly shown and described with reference to exemplary embodiments thereof, the present invention is not limited to those exemplary embodiments. It will be understood by those of ordinary skill in the art that various changes in form and details may be made therein without departing from the spirit and scope of the present invention as defined in the claims.

This application is based upon and claims the benefit of priority from Japanese Patent Application No. 2009-077100, filed on Mar. 26, 2009, the disclosure of which is incorporated herein in its entirety by reference.

It is to be noted that the optical amplifier of the present invention can include a network information reception unit that receives network information from a node device that received the network information from a network management device.

Moreover, in the optical amplifier of the present invention, the network information can be the number of multiplexed wavelengths of the optical signal that the optical amplifier itself amplifies.

### INDUSTRIAL APPLICABILITY

The present invention can be applied in, for example, an optical amplifier that amplifies an optical signal transmitted on a communication network, and an optical transmission system including the optical amplifier. In accordance with the present invention, the total optical output power in accordance with network information (e.g., the number of wavelengths of the optical signal passing through the optical amplifier) from another device such as a network management device is calculated each time, and the EDFAs and the VOA are controlled based on the optical output power that is appropriate for the network information, whereby the SRS tilt can be corrected with a simple technique.

### DESCRIPTION OF REFERENCE SYMBOLS

1a to 1c optical amplifiers
2a to 2c node devices
3 network management device
4 optical connect device

1. An optical amplifier comprising:
a front-stage amplifier that amplifies an input optical signal;
an attenuator that attenuates an output of the front-stage amplifier;
a back-stage amplifier that amplifies an output of the attenuator;
a control parameter determination unit that determines a control parameter for controlling the front-stage amplifier, the back-stage amplifier, and the attenuator so as to correct a spectral slope caused by stimulated Raman scattering of the optical signal based on network information received from another device; and
a control unit that controls the front-stage amplifier, the back-stage amplifier, and the attenuator based on the control parameter.

2. The optical amplifier according to claim 1, further comprising a network information reception unit that receives the network information from a node device that received the network information from a network management device.

3. The optical amplifier according to claim 2, wherein the network information is transmitted from the network management device to the node device at a predetermined time interval, and the control parameter determination unit determines the control parameter every the predetermined time interval.

4. The optical amplifier according to claim 2, wherein the network information is reported from an optical cross-connect device to the network management device.

5. The optical amplifier according to claim 1, wherein the network information comprises the number of multiplexed wavelengths of the optical signal that the optical amplifier itself amplifies.

6. The optical amplifier according to claim 1, wherein the control parameter comprises a total optical output power of the optical amplifier obtained by multiplying an output per channel by the number of multiplexed wavelengths.

7. An optical transmission system comprising:
node devices that form a communication network;
a network management device that acquires network information; and
an optical amplifier that amplifies an optical signal between the node devices,
wherein the optical amplifier comprises:
a front-stage amplifier that amplifies an input optical signal;
an attenuator that attenuates an output of the front-stage amplifier;
a back-stage amplifier that amplifies an output of the attenuator;
a network information reception unit that receives the network information from a node device that received the network information from the network management device;
a control parameter determination unit that determines a control parameter for controlling the front-stage amplifier, the back-stage amplifier, and the attenuator so as to correct a spectral slope caused by stimulated Raman scattering of the optical signal based on the received network information; and
a control unit that controls the front-stage amplifier, the back-stage amplifier, and the attenuator based on the control parameter.

8. A control method for an optical amplifier comprising:
determining a control parameter for controlling a front-stage amplifier that amplifies an input optical signal, an attenuator that attenuates an output of the front-stage amplifier, and a back-stage amplifier that amplifies an output of the attenuator so as to correct a spectral slope caused by stimulated Raman scattering of the optical signal based on network information received from another device; and
controlling the front-stage amplifier, the back-stage amplifier, and the attenuator, which are provided in the optical amplifier, based on the control parameter.

9. The optical amplifier according to claim 3, wherein the network information is reported from an optical cross-connect device to the network management device.

10. The optical amplifier according to claim 2, wherein the network information comprises the number of multiplexed wavelengths of the optical signal that the optical amplifier itself amplifies.

11. The optical amplifier according to claim 3, wherein the network information comprises the number of multiplexed wavelengths of the optical signal that the optical amplifier itself amplifies.

12. The optical amplifier according to claim 4, wherein the network information comprises the number of multiplexed wavelengths of the optical signal that the optical amplifier itself amplifies.

13. The optical amplifier according to claim 2, wherein the control parameter comprises a total optical output power of the optical amplifier obtained by multiplying an output per channel by the number of multiplexed wavelengths.

14. The optical amplifier according to claim 3, wherein the control parameter comprises a total optical output power of the optical amplifier obtained by multiplying an output per channel by the number of multiplexed wavelengths.

15. The optical amplifier according to claim 4, wherein the control parameter comprises a total optical output power of the optical amplifier obtained by multiplying an output per channel by the number of multiplexed wavelengths.

16. The optical amplifier according to claim 5, wherein the control parameter comprises a total optical output power of the optical amplifier obtained by multiplying an output per channel by the number of multiplexed wavelengths.
